(19) United States
(12) Patent Application Publication
(10) Pub. No.: US 2004/0200104 A1
(43) Pub. Date: Oct. 14, 2004

(54) Sign frame and panel assembly

(76) Inventor: Scott A. Schellas, Freeport, NY (US)

Correspondence Address: ABELMAN, FRAYNE & SCHWAB, 26th Floor, 150 East 42nd Street, New York, NY, 10017-5612, US

(21) Appl. No.: 10/272,018

(22) Filed: Oct. 16, 2002

(51) Int. Cl. G09F 7/02

(52) U.S. Cl. 40/611.08

(57) ABSTRACT

A sign frame includes a slot for receiving one or more sign panels. The sign frame is attached to and remains on a sign post, with the sign panels being readily removable for replacement or for changing the displayed information on the sign panels. The sign frame can have a style, such as a color or appearance, matching the aesthetic style of the community, while the sign panels can be standard signs used throughout a city or state.

### FIELD OF THE INVENTION

This invention relates to signs, and in particular to street signs for displaying messages.

### BACKGROUND OF THE INVENTION

Street signs can be fabricated from sheets or panels of metal painted to display indicia such as messages or instructions to drivers and pedestrians, street cleaning hours, pedestrian warnings and fines for municipal ordinance violations. Such signs typically include holes for mounting with threaded fasteners to sign posts having spaced apertures.

When such signs are to be changed, personnel must remove fasteners from the old sign and post, and then mount the new sign and fasteners to the post. In addition, the fasteners are typically exposed, which reduces the aesthetic appearance of the sign.

The mounting holes and placement of fasteners can also be sources of rusting, corrosion and staining leading to a reduction in the useful lifetime of the sign. The replacement of sign panels mounted by threaded fasteners is a time-consuming, labor-intensive and therefore expensive task. Nut and bolt fasteners can become corroded and difficult to remove, further complicating the work.

Furthermore, such signs are typically uniform throughout a city or other municipality. Thus, custom fabrication and expense are required to create signs that match an aesthetic style of a community, such as colors that match street or park benches.

### BRIEF SUMMARY OF THE INVENTION

A sign frame and panel assembly is comprised of a rigid sign panel mounting frame that includes a slot for receiving one or more sign panels. The sign frame is attached to, and remains on a supporting sign post, and one or more sign panels are dimensioned to be readily insertable and removable for replacement or to add sign panels with additional information.

The sign frame can be stylized by color, shape or appearance that match the aesthetic style elements in the community. The sign panel or panels can be standardized signs with informational messages or indicia used throughout a municipality or other geopolitical subdivision.

### BRIEF DESCRIPTION OF THE SEVERAL VIEWS OF THE DRAWINGS

Preferred embodiments of the invention are described below and with reference to the attached drawings, where:

FIG. 1 is a top side perspective view of a sign frame in accordance with the present invention;

FIG. 2 is a front cross-sectional view of a top portion of the sign frame of FIG. 1 along lines 2-2;

FIG. 3 is a front cross-sectional view of a bottom portion of the sign frame of FIG. 1 along lines 3-3;

FIG. 4 is a top cross-sectional view of the top portion of FIG. 2 along lines 4-4;

FIG. 5 is a side cross-sectional view of the top portion of FIG. 2 along lines 5-5;

FIG. 6 is a cross-sectional side view of the bottom portion of FIG. 3 along lines 6-6;

FIG. 7 is a front elevational view of the sign frame of FIG. 1 containing two sign panels; and

FIG. 8 is a front elevational view of the sign frame of FIG. 1 containing three sign panels.

### DETAILED DESCRIPTION OF THE INVENTION

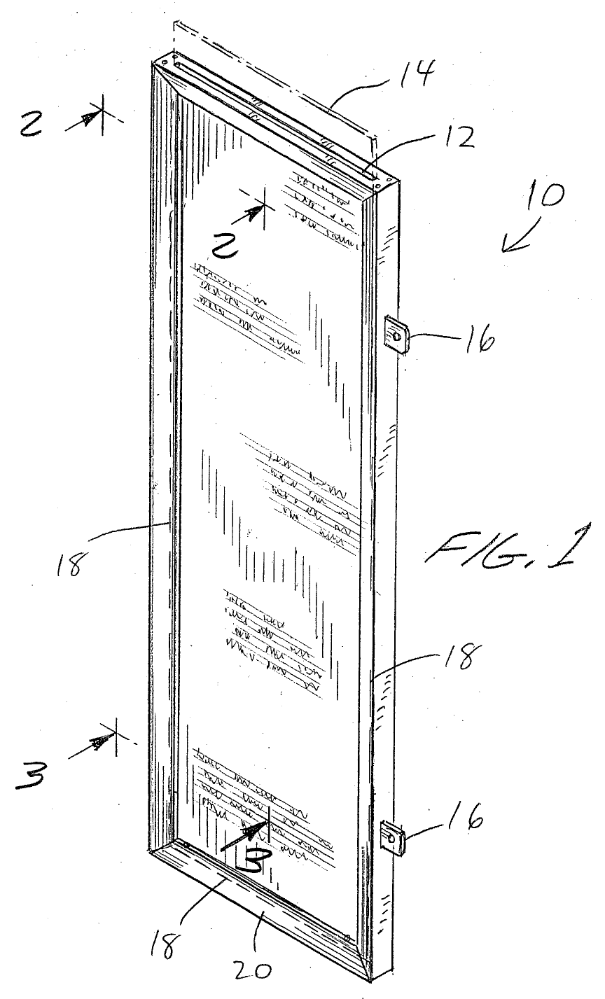

Referring to FIGS. 1-8, the sign frame 10 of the present invention includes a slot 12 for receiving one or more sign panels or blank spacer inserts 14. The sign frame 10 includes at least one mounting bracket 16 for attaching the sign frame 10 to a sign post, with the sign panels 14 being dimensioned to be readily removable for replacement or for changing the displayed information on the sign panels 14. The displayed information can be indicia or other messages, such as text and/or symbols, on one or both sides of the sign panel 14. The sign frame 10 allows both sides of the sign panel 14 to be viewed in their entirety.

The sign frame 10 can have an ornamental appearance, such as turn of the century antique or modern style that matches the aesthetic style of the community. Independent of the style or color of the sign frame 10, the sign panels 14 can be standard signs used throughout a municipality or they can be customized signs prepared for the community, for example, to display the name of the community or a community insignia, e.g., an historic village, maritime community, landmark district, and the like.

As shown in FIG. 1, the sign frame 10 includes top, bottom and side members with a slot 12 extending through the top member and extending down and meeting grooves 18 in each of the members, with the grooves 18 formed by the interior edges of the top, bottom, and side members, such that the lowermost portion of the panel 14 abuts the bottom member 20 and rests in the grooves 18.

The sign frame 10 is removably secured to a sign post by rotating brackets or clamps, (not shown) and repairable or replaceable as needed. The sign panels 14 are removably disposed in the sign frame 10, and are fabricated and intended to be replaced more easily and more often than the replacement of the sign frame 10.

In one preferred embodiment, each of the top, bottom and side members forming the sign frame 10 can be fabricated from known processes, such as extrusion of aluminum or other metals, with the mounting bracket 16 formed therefrom and/or attached thereto. One or a plurality of mounting brackets can be provided as dictated by the size of the frame. The top, bottom and side members can be fabricated as interlocking straight portions forming a rectangular sign frame 10. Alternatively, the top, bottom and side portions can be curved, forming a sign frame 10 having any predetermined shape, such as a circular sign frame.

Alternatively, the entire sign frame 10 can be fabricated by a single casting of metal or other materials, to form the frame 10 and any ornamental appearances thereon.

Any patterns or styles of appearance can be formed on the portions of the sign frame 10 by known processes. For example, the portions can be beveled to any desired angle. The frame elements can be produced by casting of ferrous and non-ferrous metals, or from polymers.

The sign frame 10 can also be painted or otherwise colored by known processes to apply a specific color, pattern of colors, and/or styles to the sign frame 10, for example, to match the overall aesthetic style of the community. For example, a community having cobblestone streets can have sign frames 10 decorated with a cobblestone appearance.

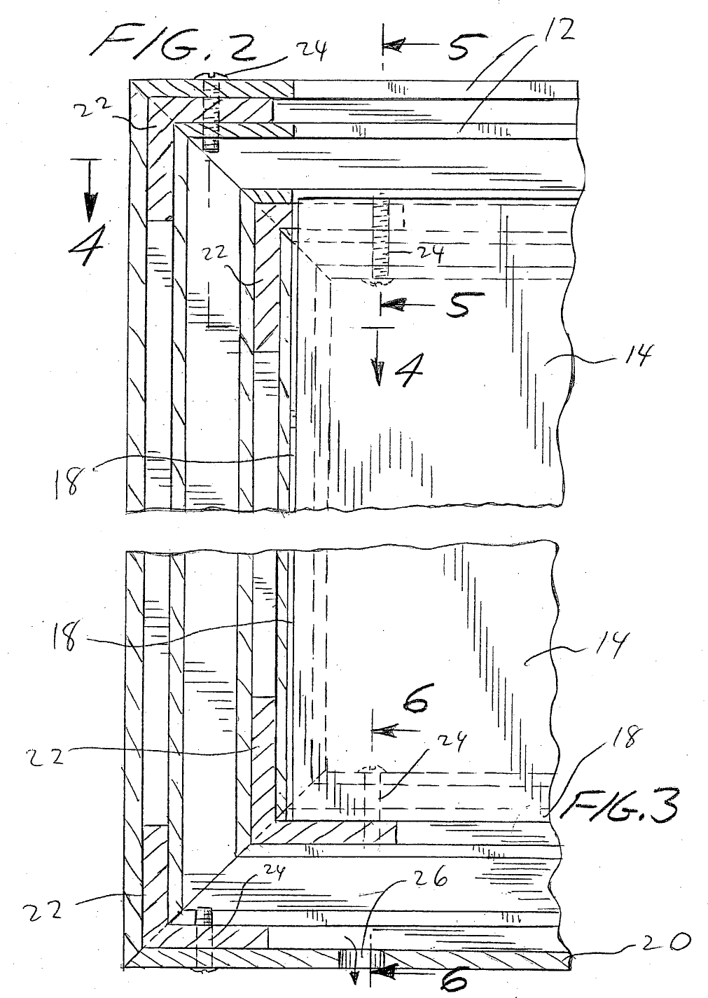

FIG. 2 illustrates a cross-section front view of a top portion of a corner of the sign frame 10 of FIG. 1, and FIG. 3 illustrates a cross-section front view of a bottom corner portion 20 of the sign frame of FIG. 1 along lines 3-3. Each of the top and bottom portions are attached to the side portions by internally-disposed angle brackets 22, securing the portions together by fasteners 24 such as rivets or set screws.

The upper end of the slot 12 through the top portion of the sign frame 10 accommodates an optional removable and/or slidable cap. The cap fits into the upper end to secure the sign panel 14 in slot 12 and in the grooves 18 of the sign frame 10. Alternatively or additionally, a sealant, such as silicone caulking, can be placed in the upper end and/or about the periphery of the exposed portion of the sign panel 14 in the sign frame 10 to secure the sign panel 14 in the sign frame 10. The sealant can optionally be used to reduce vibrations of the sign panel 14 in the sign frame from wind or other sources of movement of the sign panel in the slot 12 and the grooves 18. In a further preferred embodiment, a gasket can be placed in a portion of one or more of grooves 18, or on the edge portion of the sign panel to prevent vibration. However, in the most preferred embodiment, the thickness of the metal panel in combination with the paint or other weather-resistant coating or coatings applied to its exposed surfaces, provides for a close-fitting relation between the sign panel 14 and groove 18.

As shown in FIG. 3, the bottom member 20 includes weep holes 26, for example, three such weep holes 26 in spaced apart relation to drain rain water or melted snow which seep into the bottom member 20 from the slot 12 and the grooves 18, as well as from any space between the sign panel 14 and the slot 12 and grooves 18.

FIG. 4 illustrates a side member 28 having a side-beveled surface 30 and grooves 18 retaining at least one sign panel 14.

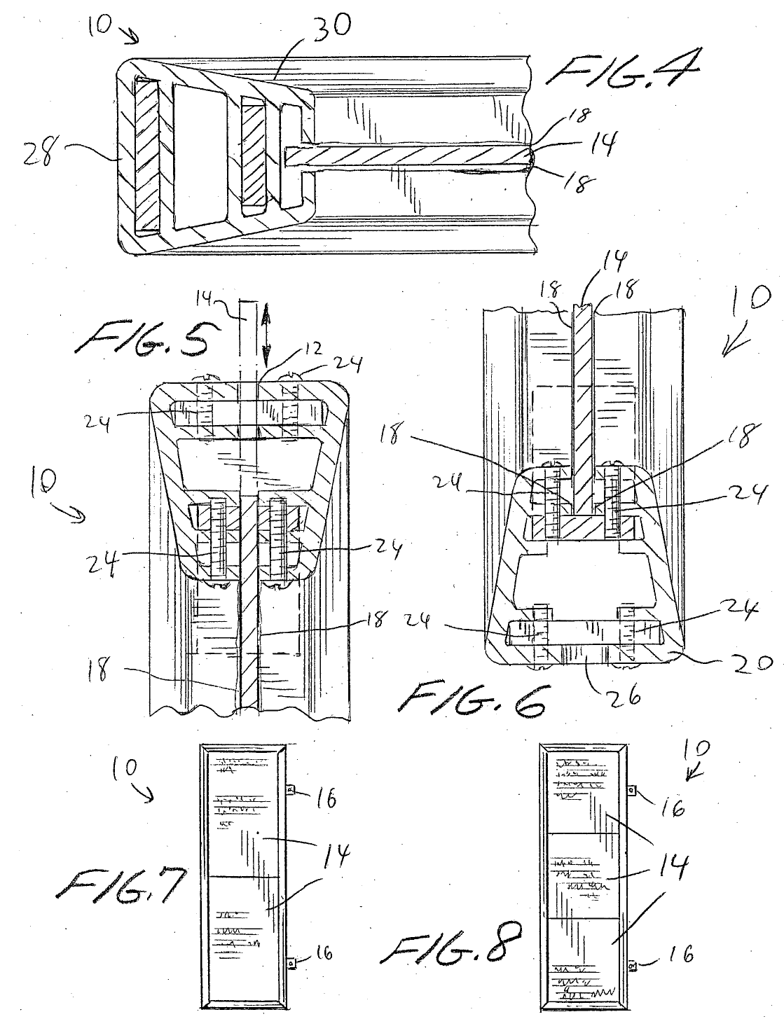

FIG. 5 illustrates a cross-section side view of the top member of FIG. 2 along lines 5-5, and FIG. 6 illustrates a cross-section side view of the bottom member 20 of FIG. 3 along lines 6-6, with the sign panel 14 disposed therein. FIGS. 5-6 show the sign panel 14 positioned for insertion or removal from the sign frame 10 via the slot 12 and the grooves 18.

FIG. 7 illustrates a front elevation view of the sign frame 10 of FIG. 1 with two sign panels 14 and FIG. 8 illustrates a front elevation view of the sign frame of FIG. 1 with three sign panels 14. Each sign panel or blank insert spacer 14 can be, for example, about 18 inches (about 46 cm.) wide, fitting into and held by the sign frame 10 exposing a portion of the sign panel 14. The exposed portion has a width of about 17 inches (about 43 cm.).

A large sign panel occupying the entire sign frame 10 can be, for example, about 66 inches (about 168 cm.) high. A medium sign panel being, for example, about 33 inches (about 84 cm.) high, occupies about half of the entire sign frame, and so two medium sign panels fit into the sign frame 10, as shown in FIG. 7. Another medium sign panel being, for example, about 22 inches (about 56 cm.) high, occupies about one third of the entire sign frame, and so three of such medium sign panels fit into the sign frame 10, as shown in FIG. 8, while a small sign panel being, for example, about 16.5 inches (about 42 cm.) high, occupies about one quarter of the entire sign frame, and so four small sign panels fit into the sign frame 10.

Alternatively, the sign panels 14 can have standardized minimum heights, for example, to be about 22 inches (about 56 cm.) high, and so limiting to three the number of sign panels 14 per sign frame 10.

Accordingly, various sizes of sign panels and inserts 14 can be accommodated in a permanently fixed sign frame 10, of any desired style, color, or appearance. The sign panels 14 are readily replaceable, and the sign frame 10 is relatively easy to secure to a sign post.

As will be understood from the above description, a sign mounting frame has been provided for holding one or more sign panels, the sign frame permitting easy replacement and changing of the sign panels. The sign frame remains on the sign post without the need of total replacement of the entire sign in order to change the sign and its displayed information. The sign frame also requires no exposed fasteners for mounting the sign panels in the frame, and the sign frame can have a style matching the aesthetic style of other elements of street furniture and amenities in a community.

I claim:

1. A sign frame which comprises:
a plurality of peripheral members, including a top member and a bottom member;
the top member having a slot therein for passing a sign panel therethrough;
wherein each peripheral member has a groove generally aligned with the slot for receiving and retaining the sign panel; and
wherein the bottom member includes at least one aperture for passing fluid therethrough so as to prevent accumulation of such fluid in the grooves.

2. The sign frame of claim 1, wherein said slot and grooves receive and retain a plurality of sign panels.

3. The sign frame of claim 1, wherein said sign panel has two sides and includes indicia on both sides.

4. The sign frame of claim 1, wherein the sign panel is removed from the grooves by passing said sign panel through said slot.

5. The sign frame of claim 1, further comprising:
a mounting bracket attached to one of the side members, for mounting the sign frame to a supporting sign post.

6. A sign assembly which comprises:
at least one sign panel; and
a sign frame including:
a plurality of peripheral members, including top member and a bottom member;
wherein the top member has a slot therein for passing the at least one sign panel therethrough; and
wherein each peripheral member has a groove generally aligned with the slot for receiving and retaining the sign panel.

7. The sign assembly of claim 6, wherein the bottom member includes at least one aperture for passing liquid therethrough so as to prevent accumulation of liquid in the grooves.

8. The sign assembly of claim 6, wherein said slot and grooves receive and retain a plurality of sign panels.

9. The sign assembly of claim 6, wherein said sign panel includes the indicia on two sides.

10. The sign assembly of claim 6, wherein the sign panel is removable from the grooves by passing said sign panel through said slot.

11. The sign assembly of claim 6 further comprising:
a mounting bracket attached to one of the side members for mounting the sign frame to an external sign post.

12. The sign assembly of claim 11, wherein the mounting bracket comprises at least two projecting members having apertures for receiving fasteners.
